(19) United States
(12) Patent Application Publication
(10) Pub. No.: US 2004/0177001 A1
(43) Pub. Date: Sep. 9, 2004

(54) Product promotion and sales in computer games, simulations, and the like

(76) Inventor: Robert Salinas, Palm Springs, CA (US)

Correspondence Address: Kenyon D. Potter, Unit C, 1180 Eddy St., San Francisco, CA, 94109, US

(21) Appl. No.: 10/733,551

(22) Filed: Dec. 10, 2003

Related U.S. Application Data
(60) Provisional application No. 60/433,255, filed on Dec. 13, 2002.

(51) Int. Cl. G06F 17/60

(52) U.S. Cl. 705/14

(57) ABSTRACT

A system and method for promotion and sale of products within computer games or simulations wherein at least one promoted product is brought to the attention of a player. Upon performing at least one action, the player may select a promoted product, receive information about the promoted product, achieve enhanced performance during game play, and/or purchase the promoted product. The various embodiments illustrate the promoted product may be anything from goods and services to contracts to interests in real property.

### PRIORITY CLAIM

The benefit under 35 U.S.C. Section 119(e) of U.S. Provisional Application No. 60/433,255, filed on Dec. 13, 2002, and entitled “Product Promotion and Sales in Computer Games, Simulations, and the like” is hereby claimed. U.S. Provisional Application No. 60/433,255 is hereby incorporated by reference in its entirety.

### COPYRIGHT RIGHTS

A portion of the disclosure of this patent document contains material that is subject to copyright protection. The copyright owner has no objection to the facsimile reproduction by anyone of the patent document or of the patent disclosure as it appears in the U.S. Patent and Trademark Office patent files or records, but otherwise reserves all copyright rights whatsoever.

### FIELD OF THE INVENTION

This invention relates to computer-implemented systems and methods for promotion including advertising, marketing, sales and so on, and in particular, to methods and systems promotion using computer games, simulations, demonstrations and the like.

### BACKGROUND OF THE INVENTION

One of the first computer games was developed in the 1950's emulated a tennis or racket type game in a virtual environment. This early computer game was known as “pong”. Development of other computer games followed this first computer game and included other action-oriented computer games as well as strategy-oriented computer games. Although development of computer games continues, the purposes of computer games have remained relatively unchanged since their inception.

Computer games have heretofore been designed and used for purposes of entertainment, instruction, and/or simulation. Many computer games are undoubtedly designed to be used for entertainment purposes. Other computer games are designed to be used for instructional purposes such as teaching or practicing skills. Still other computer games are designed to be used for simulation purposes such as planning strategy or assessing performance. Yet, still other computer games are designed to be used by a player for combined purposes. Examples of combined purposes are dual purpose games such as those which provide entertainment and instruction, or simulation and instruction. Yet, computer games have not been used for other purposes. For example, computer games have not been designed for the purpose of assisting a consumer to buy or procure of goods, services, or real estate.

Sales of computer games as the primary source of revenue in the computer game industry. Sales of computer game systems are a secondary source of revenue. However, computer game systems are often sold at or below cost in order to promote sales of computer games. Hence, whether derived from sales of box games, arcade machines, or online subscriptions, sales of computer games is the profit center of the computer game industry.

Given this industry model, the computer game industry presently lacks other sources of revenue. Except for sales and promotion of computer games themselves, a computer game or computer game system heretofore did not incorporate advertising, marketing, selling, or promotion of other products such as goods, services or real property. For example, a computer game may include advertisements of other computer games. Advertisements of other games may be in various forms including printed material inserted in game packaging or information displayed on the video screen prior to game play. Traditional advertisements may also take the form of banners, scrolling text or tickers, flashing objects, pop-up windows, frames or borders, etc. during execution of the game. One problem caused by these advertisements is that these advertisements detract from the play of the computer game. Another problem is that these advertisements reduce the display area available for playing the game. Still another problem is that advertisers and marketers did not understand that computer games represented an untapped channel for advertising, marketing, selling and promotion similar to print ads, billboards, television, radio, cable, and the internet.

As a result, computer games have remained devoid of advertisements and promotions despite the growth in product placement following the release of the motion picture The Extraterrestrial (E.T.) and the growth of the number of computer game players. Advertisements, marketing, selling or promotion was primarily limited to products within the computer game industry. For example, there are sometimes advertisements about future computer game in the form of printed box inserts or trailers akin to those used in motion pictures. The only promotion has been in computer games situated in sports arenas where virtual billboards may be used akin to billboards in actual stadiums. Heretofore, computer games have not been used as a marketing channel for promotion and sales.

### SUMMARY OF THE INVENTION

This invention relates to computer games, simulations, or the like and other interactive programs and, more specifically, to systems and methods for providing programming relating to advertising, marketing, sales, promotion or the like of goods, services or real property.

The present invention recognizes that computer games and other interactive programs attract a growing number of players like broadcast and cable television attracts millions of viewers, radio attracts millions of listeners, and the web sites attract millions of visitors. Hence, visual displays used by computer games and other interactive programs have potential as a marketing channel like television and radio are marketing channels. Yet, computer games and other interactive programs have not heretofore been recognized as a marketing channel for advertising, marketing, sales or other promotion. The present invention includes systems and methods to use advertising, marketing, selling or promotion in a computer game or interactive program. Hence, the present invention enables advertisers and marketers to overcome past failures to recognize and develop this marketing channel.

Among the past failures include recent attempts at using computer games for advertising but not marketing or actual sales. These attempts taught only the use of advertisements in computer programs such as primitive banners or pop-up windows and generally required an online connection or other connected to a remote computer. While prior art teach use of primitive advertisements, they do not teach use of promotions. More significantly, the prior art does not teach used of games or simulations for actual sales.

An object of the present invention is for advertising, marketing, sales, listing, brokering or other forms of promotion of real property. One reason that the present invention is useful for promotion of real property is that the cost of a typical computer game or simulation, whether in a box or online, is very small relative to the cost of nearly any parcel of real property. Another reason that the present invention is useful for promotion of real property is the cost of a computer game or simulation is less than the cost of other forms of promotion used in relation to real property such as listings, showings, classified advertisements, print advertisements, videos, media spots, and so on. The present invention is especially useful where a plurality of units of comparable real estate are available for sale within a single development. Hence, the marginal cost of development of a computer game is low or negligible.

Another object of the invention includes systems and methods in computer games or interactive computer programs which are useful for advertising, marketing, sales, or other promotion of anything which can be sold, leased or transferred including goods, services, real property, information, and data.

Still another object of the invention is for advertising and promotion of manufacturers and vendors of any goods and services. Manufacturers and vendors of goods and services may be advertised or promoted via signs, uniforms, labels, trademarks, trade names, or simple color schemes. In a virtual environment, one or more manufacturers or vendors sponsors a game or simulation in the way that one or more manufacturer or vendors sponsors a professional sports game in the real environment. Hence, a player may don a uniform, gear, or other good which identifies one or more sponsors including the good's manufacturer or vendor, or both, or may identify one or more additional sponsors which is neither the manufacturer or vendor of the good.

Still another object of the invention is integration of promotion and/or sales within a computer game, simulation, or the like without detracting from the entertainment value of game, simulation, or the like. Yet, still another object of the invention is the integration of sales within a game, simulation, or demonstration in a manner which enhances its value whether it be entertainment, education, or other value.

### BRIEF DESCRIPTION OF THE DRAWINGS

FIG. 1A is a schematic drawing of a circuit.

FIGS. 1B and 1C are schematic drawings of alternative circuits.

FIGS. 2A, 2B, 2C, 2D, 2E and 2F are a series of perspective drawings showing promotion, selection, and sale of a brand or a branded product or service.

FIGS. 3A, 3B, 3C, 3D, 3E and 3F are a series of perspective drawings showing promotion, selection, and sale of a product at any time before, during, or after play or during practice or training.

FIGS. 4A, 4B, 4C, 4D, 4E and 4F are a series of perspective drawings showing promotion, selection, and sale of a product at a shop.

FIGS. 5A, 5B, 5C, 5D, 5E and 5F are a series of perspective drawings showing promotion, selection, and execution of a contract relating to goods, services, or real property.

FIGS. 6A, 6B, 6C, 6D, 6E and 6F are a series of perspective drawings showing promotion, selection, and sale of a real property.

FIGS. 7, 8, and 9 are flowcharts of systems and methods of promotion and sales.

FIGS. 10A and 1B are flowcharts of alternative methods of initialization.

FIG. 11 is a flowchart of alternative methods of promotion.

FIG. 12A is a flowchart of alternative visual effects of used in promotion. FIGS. 12B and 12C are continuations of the flowchart in FIG. 12A.

FIG. 13A is flowchart of alternative methods of making a selection. FIG. 13B is a continuation of the flowchart in FIG. 13A.

FIGS. 14A, 14B and 14C are a series of drawings of a graphical object in the form of a sign.

FIGS. 15A, 15B, 15C and 15D are a series of drawings of promoted product and a label or tag.

FIGS. 16A, 16B, 16C and 16D are a series of drawings of a position indicator in simulated motion.

FIG. 17 is a series of drawings of alternative position indicators.

FIGS. 18A, 18B and 18C are drawings of alternative graphical buttons for making a selection.

FIGS. 19A, 19B and 19C are drawings of alternative graphical buttons for making a purchase decision.

FIG. 20 is a series of drawings of alternative graphical buttons.

### DETAILED DESCRIPTION OF THE INVENTION

With reference to all the drawing figures: a promoted product is depicted by a series of numerals 300, 310, 320, 330 (symbolically “3n0”); a computer game, a simulation, or the like (collectively a “computer game”) is depicted by numeral 1300; a promotion engine is depicted by numeral 1400; and an e-commerce system is depicted by numeral 1600. A promoted product may include a good, service, contract, real property, and so on. A computer game may include a computer game, simulation, demonstration, or similar interactive program. A promotion engine may include use of graphical objects, labels, symbols, colors, additional effects, and so on. An e-commerce system may include a shopping cart, merchant account, and so on.

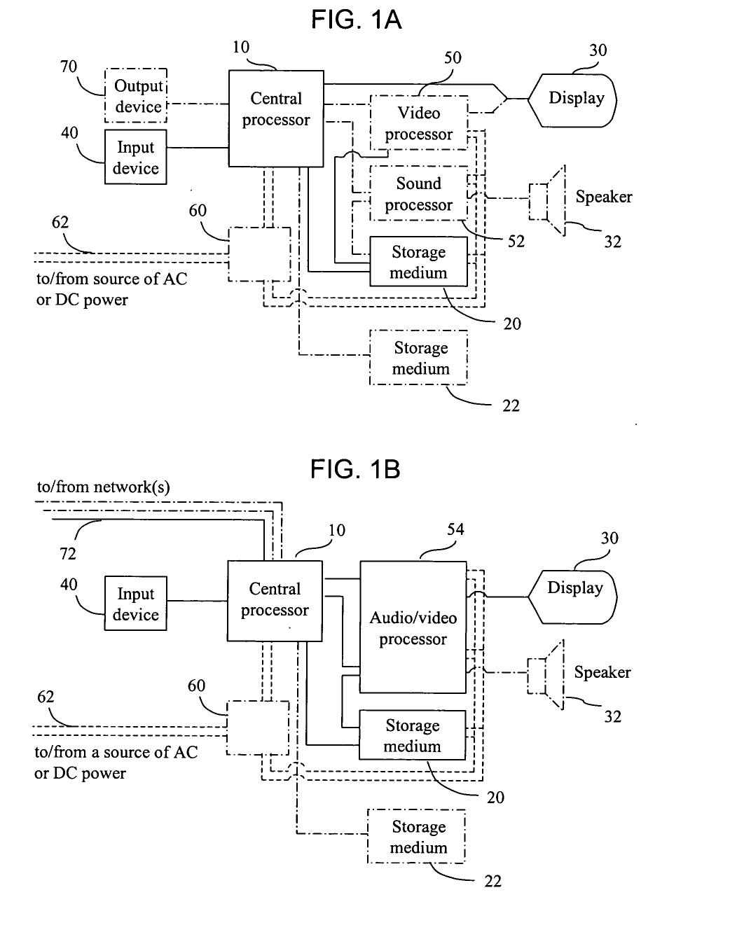

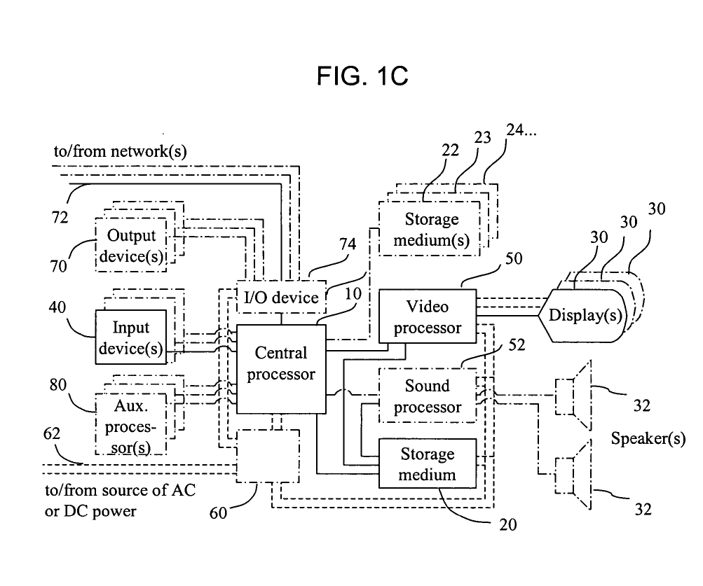

FIG. 1A is a schematic drawing of a circuit having a central processor 10 in communication with at least one storage medium 20, at least one display 30, and at least one input device 40. In one embodiment of the invention, the circuit comprises the central processor 10, the storage medium 20, the display 30, and the input device 40. In another embodiment, the circuit also comprises a video processor 50 in communication with the central processor and the display. In a further embodiment, the circuit also comprises a second storage medium 22 in communication with the central processor. In still another embodiment, the circuit also comprises an output device 70 in communication with the central processor. In yet still another embodiment, the circuit comprises a sound processor 52 in communication with the central processor and at least one speaker 32. FIGS. 1B and 1C are schematic drawings of alternative circuits showing still other embodiments. In one of these embodiments, the audio processor and video processor are a single audio-visual processor 54. In another, the central processor is in communication with a network 72. In still another, the circuit also comprises an input-output processor 74 in communication with the central processor and the network 72. In yet still another, the circuit also comprises a plurality of storage mediums 22, input devices 40, displays 30, and/or speakers 32. In yet still another, the circuit also comprises a plurality of output devices 70, auxiliary processors 80, and/or networks 72. The circuit may be housed or situated within a game box, cartridge, console, or personal computer. In FIGS. 1A, 1B and 1C, bus or electric power lines are shown by dashed lines and alternative components and devices are shown by phantom, or dot-dash, lines.

In operation, the central processor receives input communicated from the input device 40, processes said input in accordance with instructions and/or data communicated from the storage medium 20, and transmits output to the display 30. Where the input device is not a keyboard or mouse, the input device may be a game controller of the type manufactured by Thrustmaster of Montreal, QC. Where a speaker 32 is present, the central processor or audio processor also transmits output to the speaker. The storage medium 20 records information communicated from the central processor. In one embodiment the storage medium may be a hard drive of the type manufactured by Quantum Corp. of Milpitas, Calif. Alternatively, the central processor receives instructions and/or data from the storage medium 20 and/or a second storage medium 22. The second storage medium 22 may be a DVD, CDROM, memory stick, programmable read only memory (PROM), electronically-alterable programmable memory (EPROM), or the like. In another embodiment, the second storage medium 22 is an integrated circuit housed within a game box. In still another embodiment, the second storage medium is a CDROM which is removeably connected to the circuit.

The circuit and is powered by a source 62 of direct current (DC) power or alternating current (AC) power. Where the source is AC power, a transformer 60 is in communication with the source 62. The transformer may be a board-mounted transformer of the magnetic type manufactured by Hammond Manufacturing of Cheektowaga, N.Y. or a stand-alone power adapter of the type manufactured by Motorola Corporation of Schaumburg, Ill. Where the mode is online, the central processor is in communication with the network 72 and the input-output device 74 may be a network card of the type manufactured by Novell Communications of Provo Utah; a dial-up modem of the type manufactured by Hayes Corporation of Boston Mass.; or an alternative type of modem such as wireless, DSL, or cable modems which remain “always-on”. In still another embodiment, the central processor is in communication with a third storage medium 23 at a remote location whereby information about the game operational parameters, promotions, selections, and/or purchase decisions are transmitted to and from the remote location. In still yet another embodiment, the central processor is in communication with a fourth, fifth, sixth, etc. storage mediums 24, 25, 26, etc. at multiple locations.

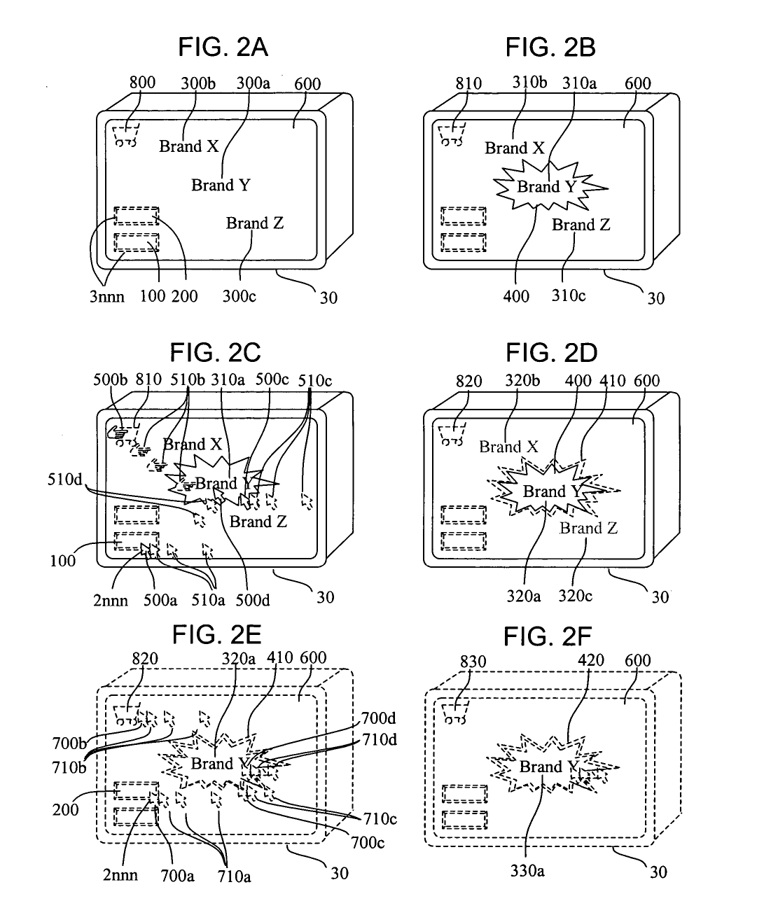

With reference to FIGS. 2 through FIG. 6, a graphical object representing a promoted product is depicted by a series of numerals 300a, 310a, 320a . . . (collectively “3n0a”); a graphical object or visual effect representing a promotion 14nn is depicted by a series of numerals 400, 410, 420 . . . (collectively “4n0”); alternative methods for making a selection using a position indicator are depicted by a series of numerals 500a, 500b, 500c, 500d, 500e . . . (collectively “500”); alternative methods of making a purchase decision are depicted by numerals 700a, 700b, 700c, 700d, 700e . . . (collectively “700”). The screen 600 of the display 30 shows a graphical objects depicted by numerals 100 and 200 for use in making a selection 500a and making a purchase decision 700a, respectively. In one embodiment, the screen shows a graphical object 810 for use in making a selection 500b and/or a graphical object 820 for use in making a purchase decision 700b. The screen may also show a graphical object 910 for use in making a selection 500e and/or a graphical object 920 making a purchase decision 700e. In another embodiment, the screen shows a graphical object 310a representing the promoted product for use in making a selection 500d or a graphical object 320a representing the promoted product making a purchase decision 700d. In still another alternative, the screen shows a graphical object 400 representing the promotion for use in making a selection 500c or a graphical object 410 representing the promotion making a purchase decision 700d.

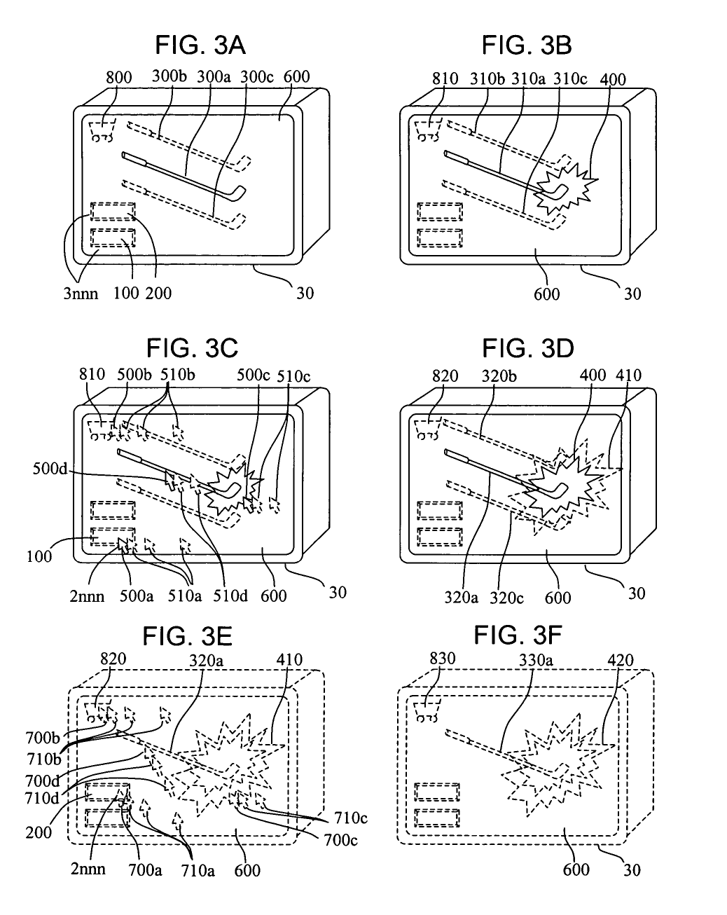

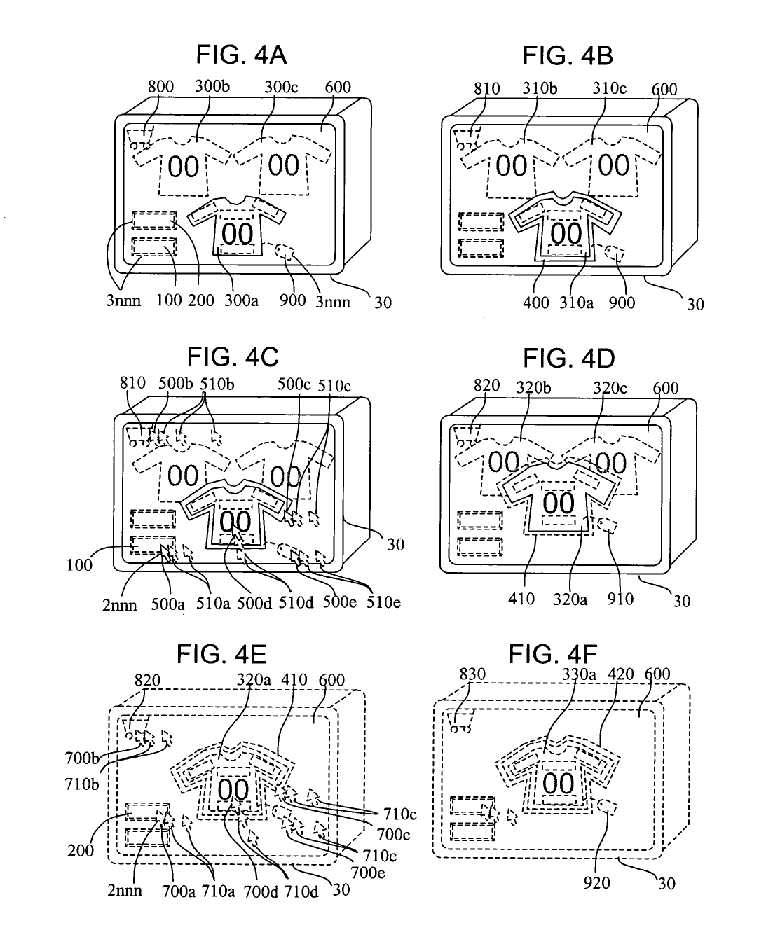

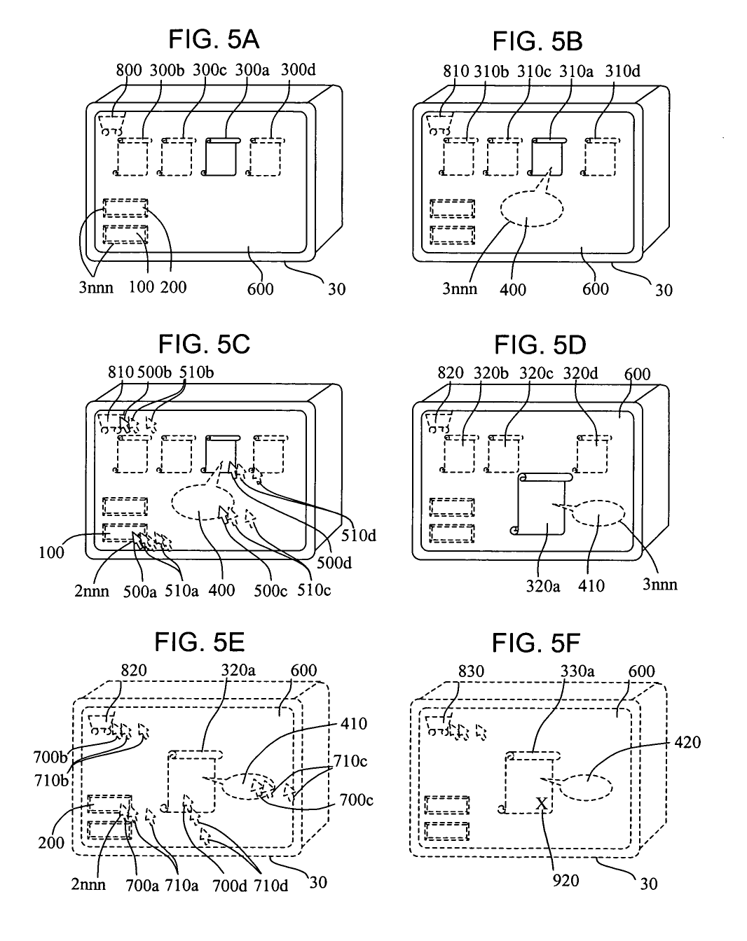

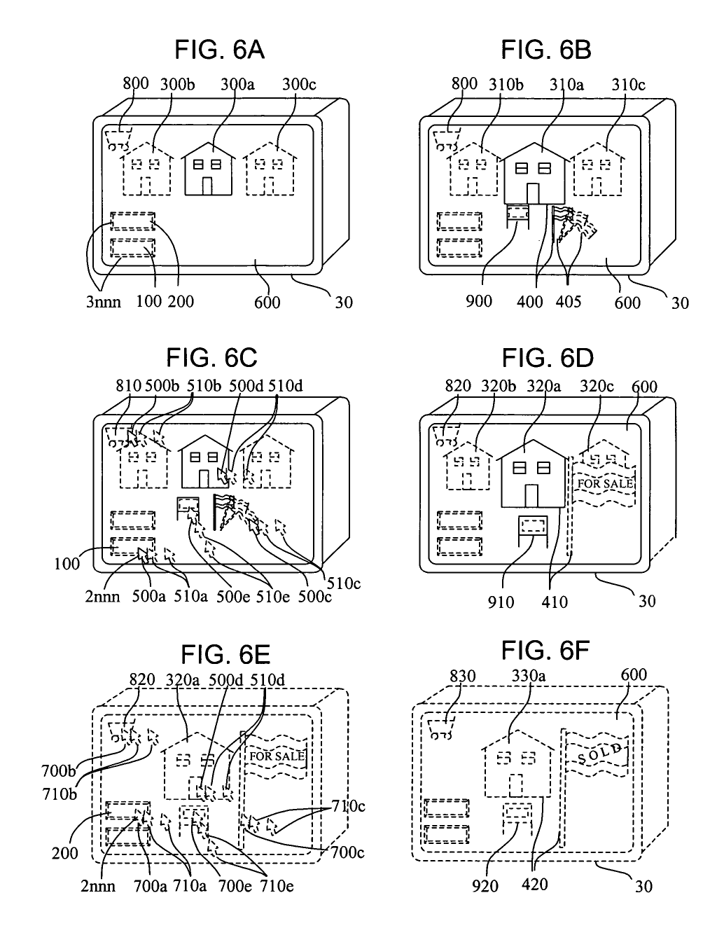

FIGS. 2A, 2B, 2C, 2D, 2E and 2F are a series of perspective drawings showing promotion, selection, and sale of a brand or a branded product or service at any time before, during or after operation of the computer game. FIGS. 3A, 3B, 3C, 3D, 3E and 3F are a series of perspective drawings showing promotion, selection, and sale of a product such as a golf club(s) at any time before, during, or after play or during a practice or training session. FIGS. 4A, 4B, 4C, 4D, 4E and 4F are a series of perspective drawings showing promotion, selection, and sale of a product such as a shirt off the rack at a shop. FIGS. 5A, 5B, 5C, 5D, 5E and 5F are a series of perspective drawings showing promotion, selection, and execution of a contract for the sale of goods, services, or real property. FIGS. 6A, 6B, 6C, 6D, 6E and 6F are a series of perspective drawings showing promotion, selection, and sale of a real property. In FIGS. 2A through 6F, alternative objects are shown by dashed lines.

In FIGS. 2A-2F and 3A-3F, the graphical objects 100 and 200 are images of rectangular buttons, the graphical objects 8n0 are images of a shopping cart, and the visual effect 400 representing a promotion 14nn is an starburst effect 1750t whereby graphical object 310a is essence graphical object 300a surrounded by a starburst, explosion or the like. In FIGS. 4A-4F, the graphical objects 100 and 200 are images of rectangular buttons, the graphical objects 8n0 are images of a shopping cart, the graphical objects 9n0 are images of a label or tag, and the visual effect 400 representing a promotion 14nn is an aura effect 1750r whereby graphical object 310a is graphical object 300a surrounded or silhouetted by an aura, glow, or the like. In FIGS. 5A-5F, the visual effect 400 representing a promotion 14nn is a callout effect 1750s whereby graphical object 310a is same as graphical object 300a except for the callout effect. In FIGS. 6A-6F, the graphical objects 100 and 200 are images of rectangular buttons and the visual effect 400 representing the promotion 14nn includes a zoom-in effect 1750g whereby graphical object 310a is an enlargement of graphical object 300a. In addition, FIGS. 6A-6F show a second visual effect 400 representing the promotion 14nn is a flag or banner 1750ii in the vicinity of graphical object 310a. In another embodiment, the visual effect 400 representing the promotion 14nn includes combination of colorization effect 1750h and de-colorization effect 1750k whereby graphical object 310b is pronounced but remains unchanged in size from graphical object 300a. In still other embodiments, graphical object 310a may be changed or unchanged from 300a and graphical objects 4n0 are one or more effects 1750a . . . 1750zz including callouts, outlines, auras, starbursts, colorization, and so on. In yet still other embodiments, the graphical objects 100, 200, 4n0, 8n0, and 9n0 may be buttons or other graphical objects having various shapes or styles or be text, symbols, iconographics, drawings, pictures, images, effects and so on.

The screen 600 of the display 30 also shows a promoted product 3n0 and a promotion 4n0 for use in either making a selection or making a purchase decision. Making a selection and making a purchase decision may be made using the position indicator alone or in combination with physical buttons or keys on the input device 40 depending on a predetemined event or events communicated from the input device. Alternately, selection and making a purchase decision may be made by physical buttons or keys alone on the input device 40.

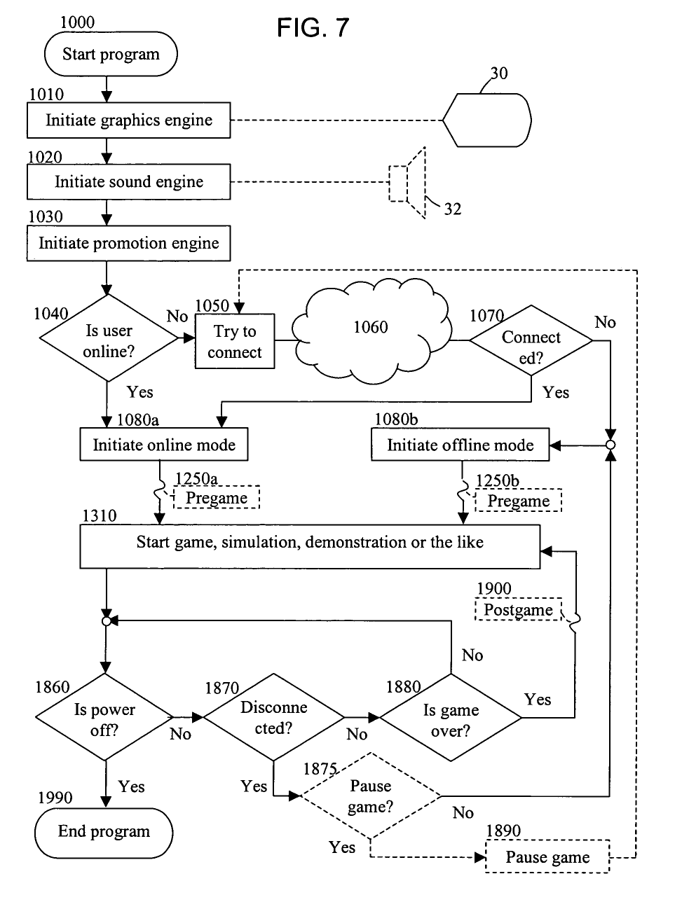

In FIGS. 7, 8 and 9 flowcharts show the system and methods of promotion and sales. In FIGS. 7,8 and 9, alternative steps are shown by dashed lines. In FIG. 7 the flowchart shows the steps of initiating the graphics engine 1010; initiating the sound engine 1020; initiating the promotion engine 1030; checking if online 1040; trying to connect 1050; checking if connected 1060; initiating the online mode 1080a or initiating the offline mode 1080b; starting game, simulation or the like 1310; checking if power if off 1860; checking if disconnected 1870; checking if game is over 1880; and/or ending program 1990. In FIG. 7, the flowchart also shows a step of communication over a network 1060 as well as alternative steps of conducting a pre-game in online mode 1250a; and conducting a pre-game in a offline mode 1250b; conducting a post-game 1900; checking if to pause game 1875; pausing game 1880.

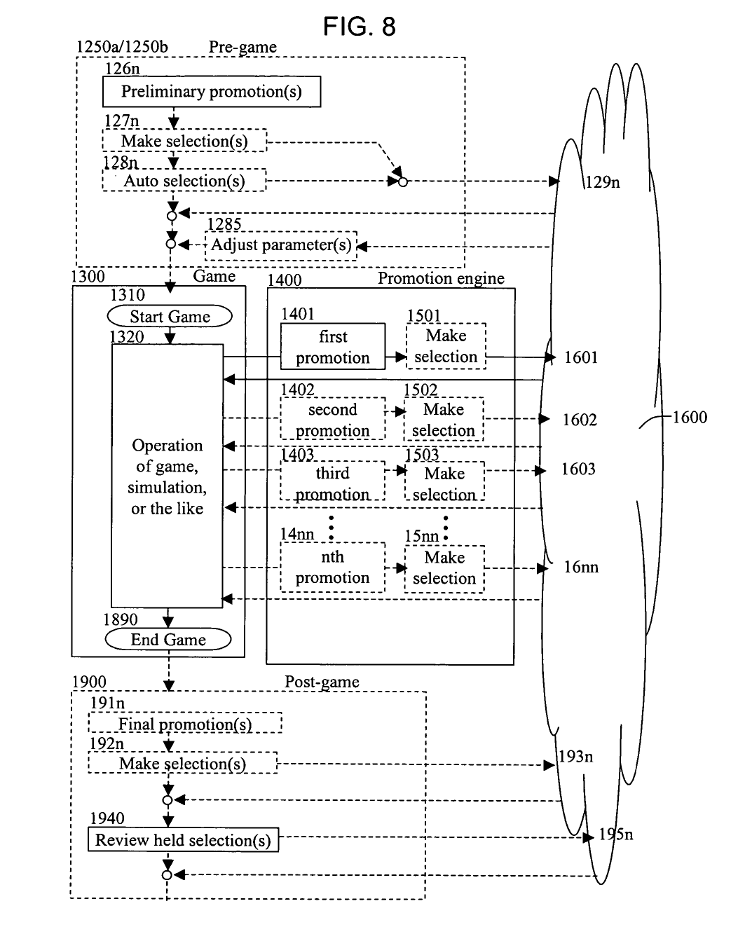

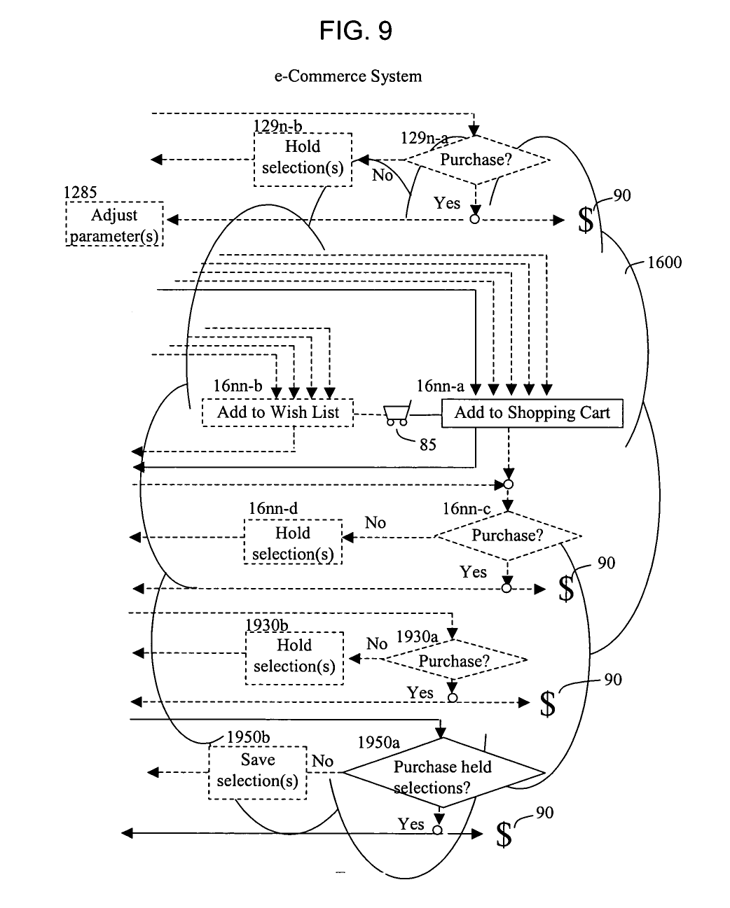

In FIGS. 8 and 9 a flowchart shows the steps of a game 1300, a promotion engine 1400, and an e-commerce system 1600. The e-commerce system includes a shopping cart 85 for holding selections and a merchant account or the like 90 for making purchases and performing financial transactions. The flowchart also shows alternative steps pre-game 1250a (or 1250b) and a post-game 1900. In the game, the flowchart shows steps of starting game 1310, operating game, simulation or the like 1320, and end game 1890. In the promotion engine, the flowchart shows steps of a series of promotions 1401, 1402, 1403 . . . 14nn (collectively 14nn) and a series of making selections 1501, 1502, 1503 . . . 15nn (collectively 15nn). In the pre-game, the flowchart shows alternative steps of making a series of preliminary promotion(s) 1261, 1262, 1263 . . . 126n (collectively 126n); making a series of selection(s) 1271, 1272, 1273 . . . 127n (collectively 127n); a series of auto selection(s) 1281, 1282, 1283 . . . 128n (collectively 128n); and adjusting operational parameters 1285. In the post-game, the flowchart shows the step of reviewing held selection(s) 1940. In the post-game, the flowchart also shows alternative steps of making a series of final promotion(s) 1911, 1912, 1913 . . . 191n (collectively 191n) and making a series of selections 1921, 1922, 1923 . . . 192n (collectively 192n). The flowchart also shows communication with an e-commerce system 1600 in which occur the alternative steps of making a purchase decision during the pre-game 1290, making a series of purchase decisions during the game 1601, 1602, 1603 . . . 16nn (collectively 16nn), making a series of purchase decisions after the game 1931, 1932, 1933 . . . 193n (collectively “193n”), or making a purchase decision after review the held selections 1950.

In operation, a game player is able to make a single selection 1501 or a series of selections 15nn following the corresponding promotion(s) 14nn and a player is able to make a single purchase 1601 or a series of purchases 16nn following the corresponding selection(s) 15nn. A single promotion 1261 or series of promotions 1261, 1262, 1263 . . . 126n may occur before the before the game 1300. A game player is able to make a single selection 1271 or a series of selections 127n following the promotion(s) 126n and a player is able to make a single purchase decision 1281 or a series of purchase decisions 128n following the selection(s) 127n. If the game player does not make a selection or series of selections, a single auto selection 1280 or a group of auto selections 128n is able to be made automatically. Similarly, a single promotion 1911 or series of promotions 1911, 1912, 1913 . . . 191n may occur after the game 1300. A game player is able to make a single selection 1921 or a series of selections 192n following the promotion(s) 191n and a player is able to make a single purchase decision 1931 or a series of purchase decisions 193n following the selection(s) 192n. In FIG. 9, the flowchart shows a series of steps of adding to shopping cart 16nn-a and the step of making a purchase decision after reviewing held selections 1950a. The flowchart shows the alternative steps of making purchase decision(s) 1290a; holding selection(s) 1290b before the game; adding to wish list 16nn-b; making a purchase decision 16nn-c; and holding a selection 16nn-d during the game; making purchase decisions 1930a and holding selection(s) 1930b after the game; and making purchase decisions 1950a and saving selection(s) 1950b after reviewing held selections 1940. The alternative steps hold selections 1290b, hold selections 16nn-d, and hold selections 1930b include selections adding to shopping cart similar to step 16nn-a. The alternative step save selections 1950b includes saving the shopping cart to at least one storage medium 20 or 22.

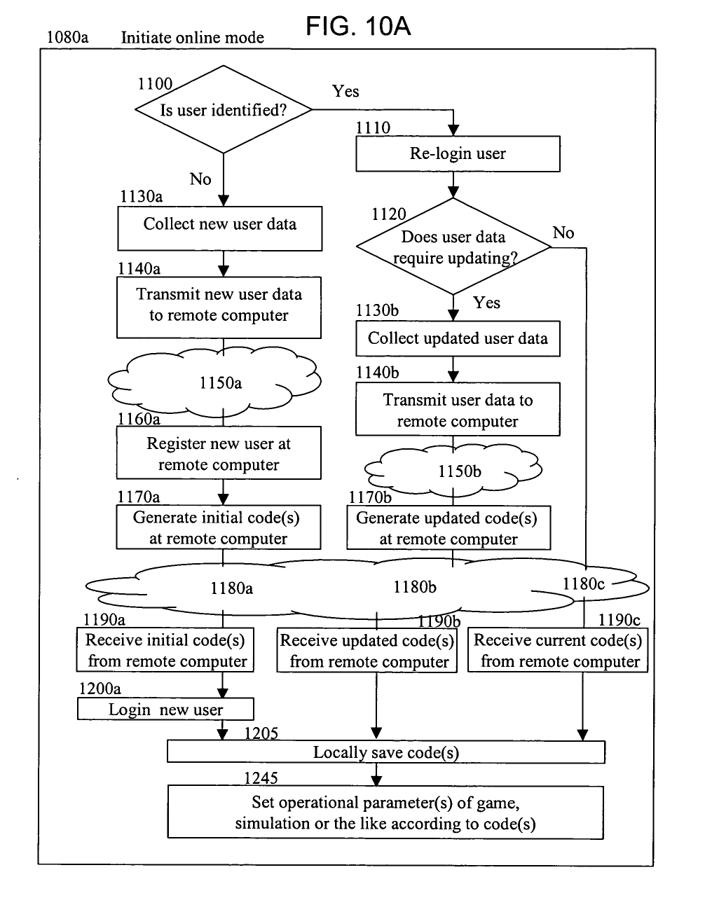

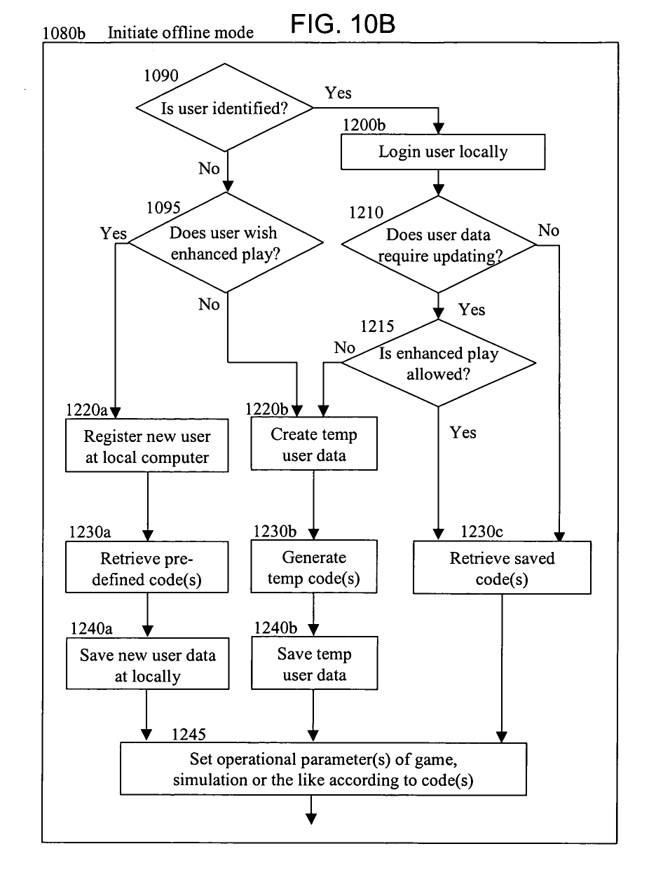

FIGS. 10A and 10B show flowcharts of initializing online mode 1080a and offline mode 1080b, respectively. In FIG. 10A, a flowchart shows the steps of checking user identity 1100, re-login user 1110, checking if user data requires updating 1120, receiving current code(s) from remote computer 1190c, locally-saving code(s) 1205, and setting operational parameter(s) of game according to code(s) 1245. The flowchart shows the alternative steps of collecting new user data 1130a; transmit new user data to remote computer 1140a; registering new user at remote computer 1160a; generating initial code(s) at remote computer 1170a; receiving initial code(s) from remote computer 1190a; and login new user 1200a or the alternative steps of collecting updated user data 1130b; transmit updated user data to remote computer 1140b; generating updated code(s) at remote computer 1170b; and receiving updated code(s) from remote computer 1190b. The flowchart also shows communication with a network 72 at intermediate steps 1150a/b and 1180a/b/c. In operation, locally-saving may includes communication with at least one storage medium 20 or 22 and may include communication through the network 72. Initial or updated code(s) may be used to set the operational parameters of the game or simulation including the complexity and details of the game or simulation, the presence or not of teammates or competitors, and each player's attributes such as speed, skill, stealth, power, invincibility, and so on. Determination of initial and updated code(s) may depend on various factors. The initial codes may be based on information such as user demographics, interests, preferences, planned purchases taken from user data and/or targeted promotion or marketing codes corresponding to short duration or long-lasting promotions. The updated codes may be based on the same information to the initial codes plus additional information such as player performance, player frequency, actual purchases, and brand loyalty.

In FIG 10B, a flowchart shows the steps of checking user identity 1090, login in user locally 1200b, checking if user data requires updating 1210, checking if enhanced play is allowed 1215, retrieve locally-saved code(s) 1230c, and setting operational parameter(s) of game according to code(s) 1150. The flowchart shows the alternative steps of checking if user wishes enhanced play 1095; registering new user at locally 1220a; retrieving pre-defined code(s) 1230a; saving new user data at locally 1240a or the alternative steps of checking if enhanced play is allowed 1215; creating temp user data 1220b; generating temp code(s) 1230b; and saving temp user data 1240b. Although the flowchart does not show communication with the network 72, locally-saved and locally-registering includes communication with at least one storage medium 20 or 22 and may include communication through the network 72. Predetermined or temp code(s) may be used to set the operational parameters of the game or simulation including the complexity and details of the game or simulation, the presence or not of teammates or competitors, and each player's attributes such as speed, skill, stealth, power, invincibility, and so on. The predetermined and temp code(s) may depend on various factors. The predetermined code(s) may be based on information such as assumptions of user demographics. The temp code(s) may be based on user demographics, interests, preferences, and/or targeted promotion or marketing codes corresponding to long-lasting promotions.

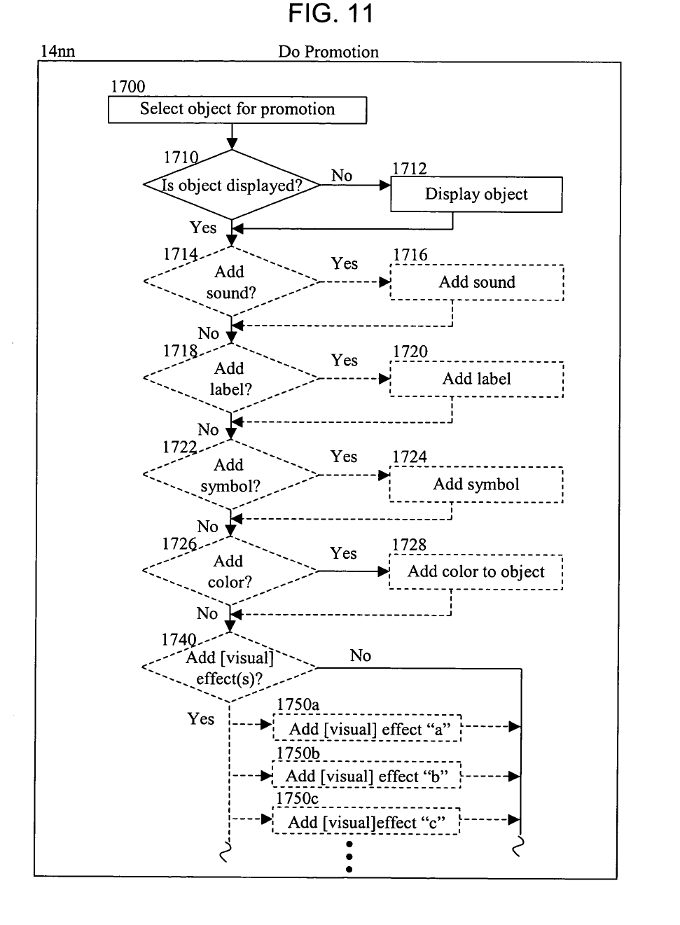

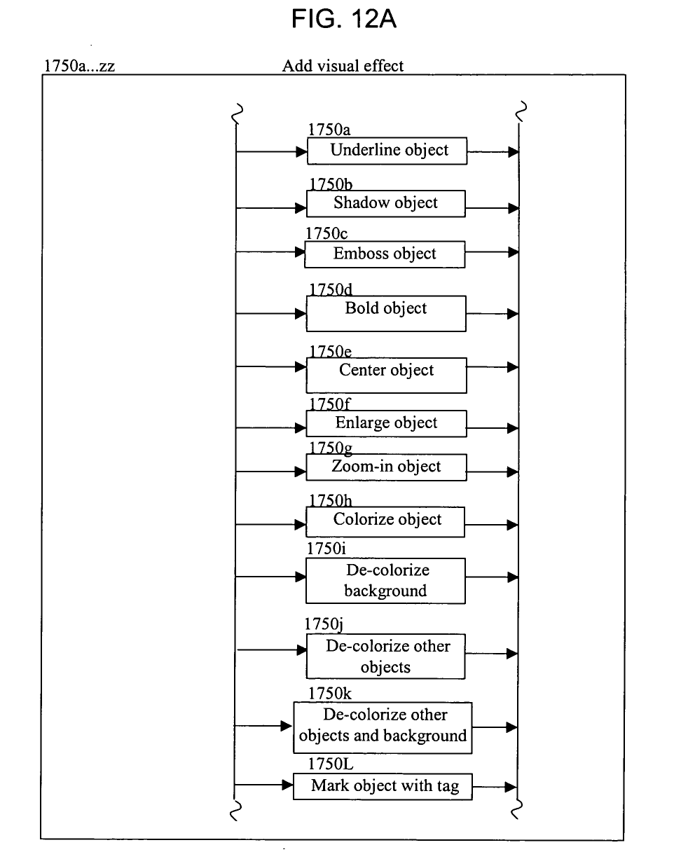

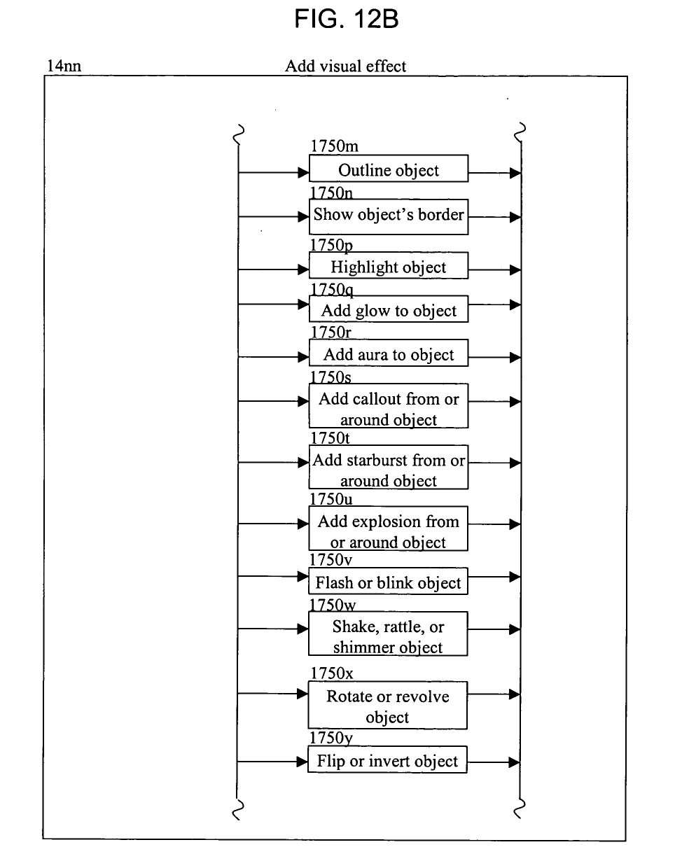

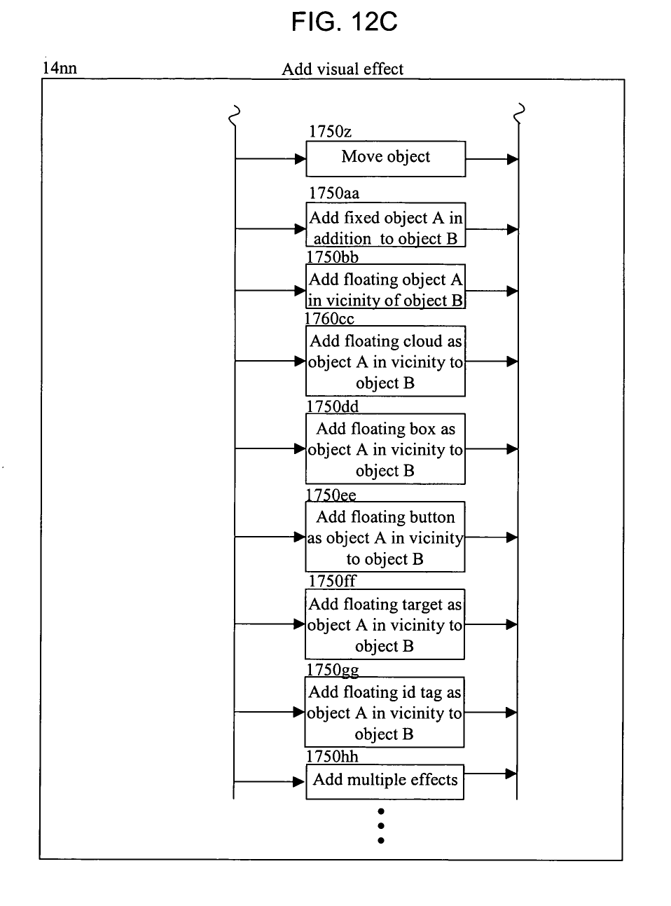

With reference to FIGS. 11, 12A, 12B, and 12C, an object refers to a graphical object. FIG. 11 shows a flowchart of methods of conducting a promotion 14nn. The flowchart shows the steps of selecting object for promotion 1700; checking if object is displayed 1710; and displaying object 1712. The flowchart also shows the alternative steps of checking if sound(s) need be added 1714; adding sound(s) 1716; checking if label(s) need be added 1718; adding a label(s) 1720; checking if symbol(s) need be added 1722; adding symbol(s) 1724; checking if color(s) need be added 1726; adding color(s) 1728; checking if one or more [visual] effect(s) need be added 1740; and adding one or more effect(s) 1750a, 1750b, 1750c . . . to an object. Although generally visual effects, effects may also include audio-visual or even non-visual effects such as tactile or olfactory. FIG. 12A is a flowchart of alternative visual effects as part of conducting a promotion. FIGS. 12B and 12C are continuations of the flowchart in FIG. 12A. The flowchart shows the addition of one or more visual effect(s) 1750a . . . 1750hh to a promoted product 300a as part of a promotion 14nn. Visual effects include underlining an object 1750a, shadowing an object 1750b, embossing an object 1750c, and so on. Additional visual effects will be apparent to one skilled in the art. For example, another visual effect is a waving flag, banner, or the like 1750ii. It will be appreciated that certain visual effects or combinations of effects are more likely to be effective than others for purposes, of promotion. For example, visual effects which enlarge an object 1750f, zoom-in an object 1750g, add glow to object 1750q, add aura to object 1750r, add starburst to object 1750t, add explosion around object 1750u, add callout to object 1750s, and colorize an object 1750h, and multiple effects 1750hh such as combination of 1750h and 1750k are more likely to be effective.

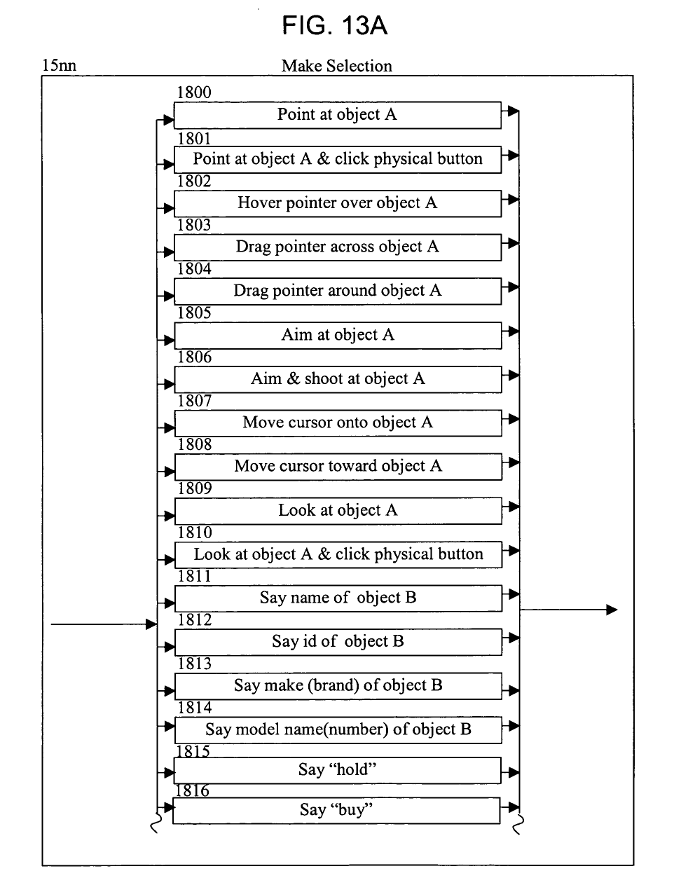

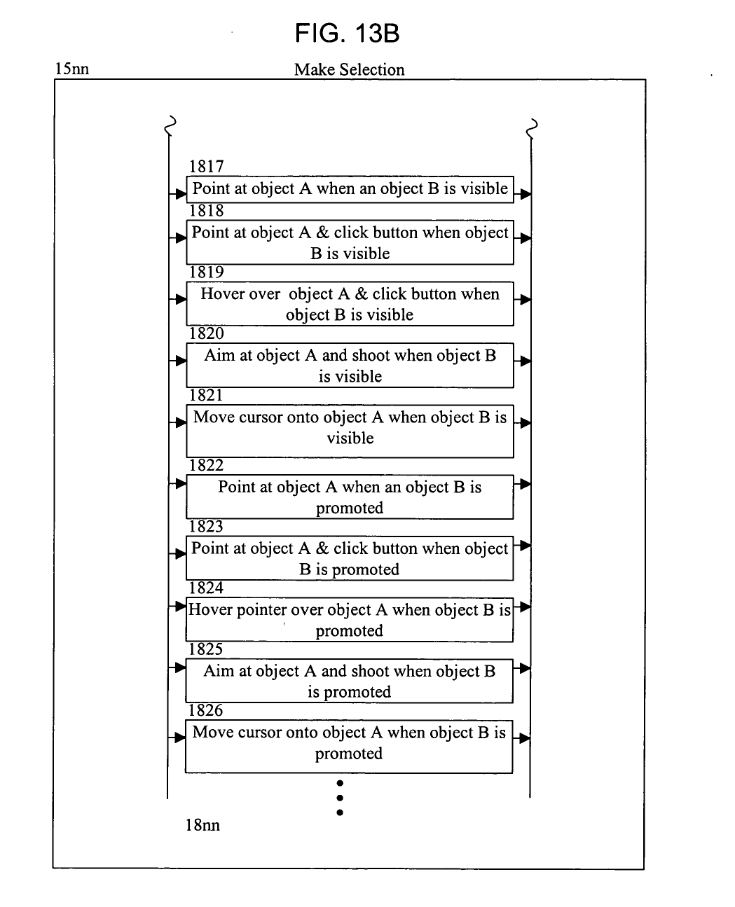

FIG. 13A is flowchart of alternative methods of making a selection 1800, 1801, 1802 . . . 18nn (collectively “18nn”). FIG. 13B is a continuation of the flowchart in FIG. 13A. With reference to FIGS. 13A, 13B, and 13C, object A may refer to many graphical objects 100, 810, 310a, 400, and so on while object B refers to the graphical object representing a promoted product 310a. Methods of making a selection 18nn include pointing at object A 1800; point at object A and click physical button 1801; hover pointer over object A 1802; drag pointer across object A 1803; and so on. Other methods of making a selection will be apparent to a person skilled in the art. For example, making a selection may be accomplished by pressing a physical button or buttons on an input device 40 such as typing a predetermined key or combination of key on a keyboard. It will be appreciated that certain methods of making selections are more convenient than other methods. For example, physical button on the input device may not be available for use given the requirements of a given game, simulation, or the like. It will also be appreciated that methods of making a selection may also apply to methods of making purchase decisions 129n, 16nn, 193n, 195n. It will be appreciated that it may be convenient or even necessary to restrict the making of purchase decisions to before and/or after the game or simulation rather than during the game or simulation. It may also be convenient to restrict the making of selections to before and/or after the game or simulation. Regardless of these restrictions, conducting promotions 14nn could continue throughout the game. In addition, in the pre-game, auto selections 128n could selected one or more promoted products if a player did not make selections 127n. In the post-game, final promotions 191n could repeat earlier promotions 14nn allowing the player to make selctions 192n. In this way, distractions could be avoided and the value of the game or simulation would not be diminished. This is particularly true in cases of fast-paced or real-time games, simulations or the like.

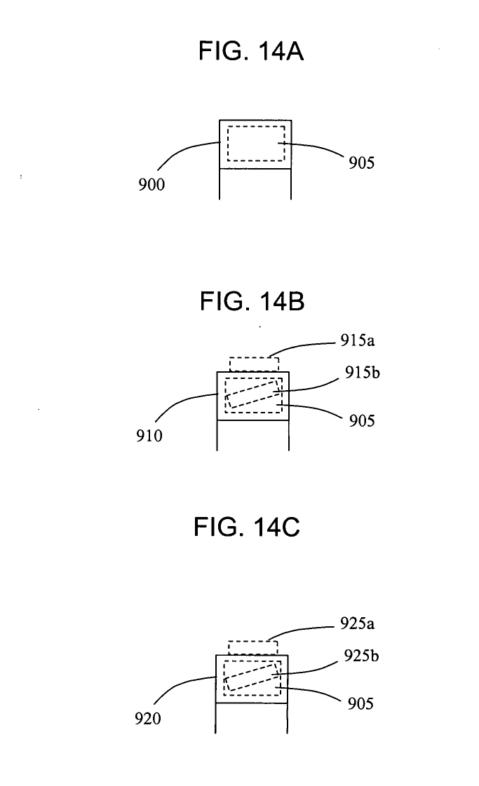

FIGS. 14A, 14B and 14C are a series of drawings of a graphical object in the form of a sign. In FIG. 14A a graphical object 900 is an a-frame sign with a first horizontal box 905. In FIG. 14B, a graphical object 910 is the a-frame sign with the first horizontal box 905, a second horizontal box 915a, and a diagonal box 915b following a promotion 126n, 14nn, or 191n. In FIG. 14C, a graphical object 920 is the a-frame sign with a first horizontal box 905, a second horizontal box 925a, and a diagonal box 925b following a making a selection 127n, 15nn, or 192n. In operation, the boxes 905, 9n5a, and 9n5b may contain text, numerals, images, or so on. For example, horizontal box 905 may have the text “for sale” and horizontal box 925a and diagonal box 925b may have the text “sold.” Alternatively, the horizontal box 905 may be have the image or colors of a brand. It will be appreciated that a graphical object in the form of a sign may be effective for promotion of various products.

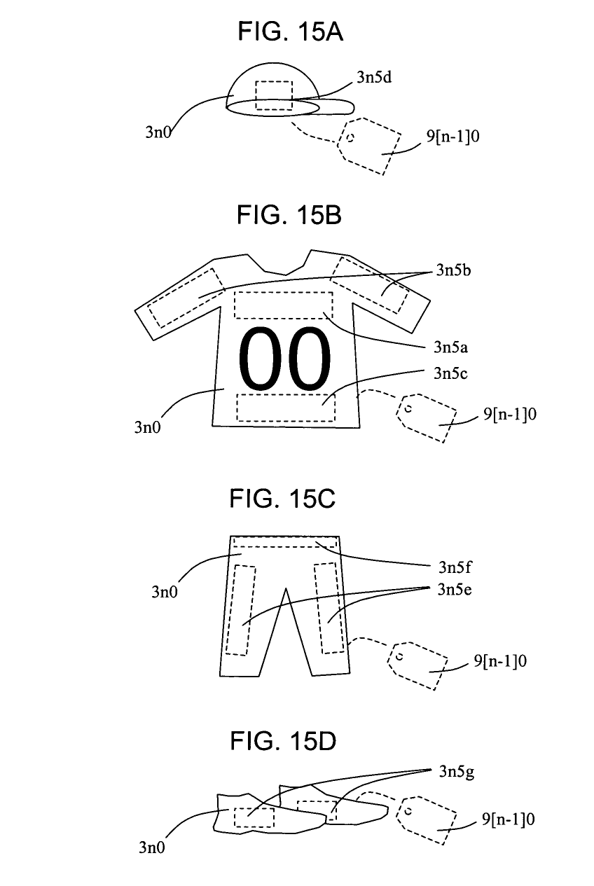

FIGS. 15A, 15B, 15C and 15D are a series of drawings of a graphical objects representing promoted products 3n0 having a label or tag. In FIG. 15A the graphical object 3n0 is cap with a label 3n5d across the brow and a tag 9[n-1]0. In FIG. 15B the graphical object 3n0 is shirt with a label 3n5a across the breast, a label 3n5c across the waist, labels 3n5b along the shoulders and arms, and a tag 9[n-1]0. In FIG. 15C the graphical object 3n0 is pants with a label 3n5f across the waist, labels 3n5e down legs, and a tag 9[n-1]0. In FIG. 15D the graphical object 3n0 is shoes with a label 3n5g across the side and a tag 9[n-1]0. In operation, the labels 3n5a, 3n5b, 3n5c, . . . 3n5g and the tag 9[n-1]0 may contain text, numerals, images, or so on. It will be appreciated that the brand of a promoted product may be identified by brand name, symbol or logo located on a label or tag of a promoted product. It will also be appreciated that certain brands may be more easily identified by the use of a distinctive combination of colors, shapes or patterns. Hence, a graphical object representing a promoted product 310a may not require labels if distinctive colors, shapes or patterns are employed.

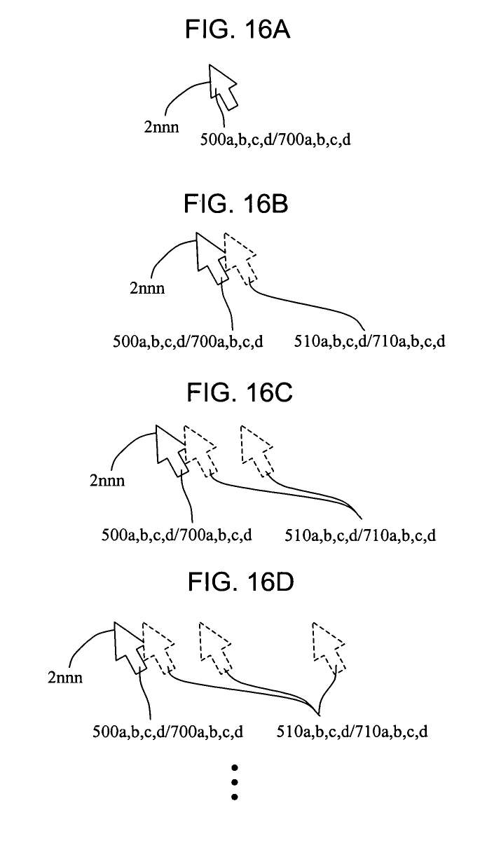

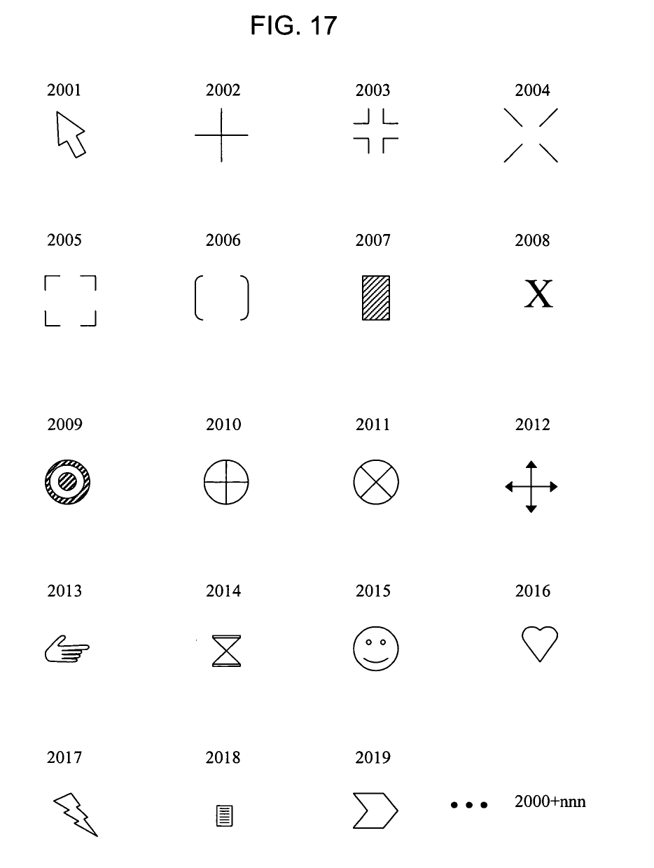

FIGS. 16A, 16B, 16C and 16D are a series of drawings of a position indicator 2nnn in simulated motion. In FIGS. 16A through 16D, a position indicator is a pointed arrow 2001 similar to position indicators in windows-based operating systems of the type manufactured by Microsoft Corporation of Redmond, Wash. In FIG. 16A the position indicator does not show a trail. In FIGS. 16B, 16C, and 16D, the trail of the position indicator is incrementally longer. FIG. 17 is a series of drawings of alternative position indicators 2nnn. For example, a position indicator may be one of many a targets 2002, 2003, 2004, 2005, 2009, 2010, 2011, 2012 and so on. It will be appreciated that a graphical object used as a position indicator 2nnn may take the form of nearly anything including a symbol, icon, or image of a promoted product.

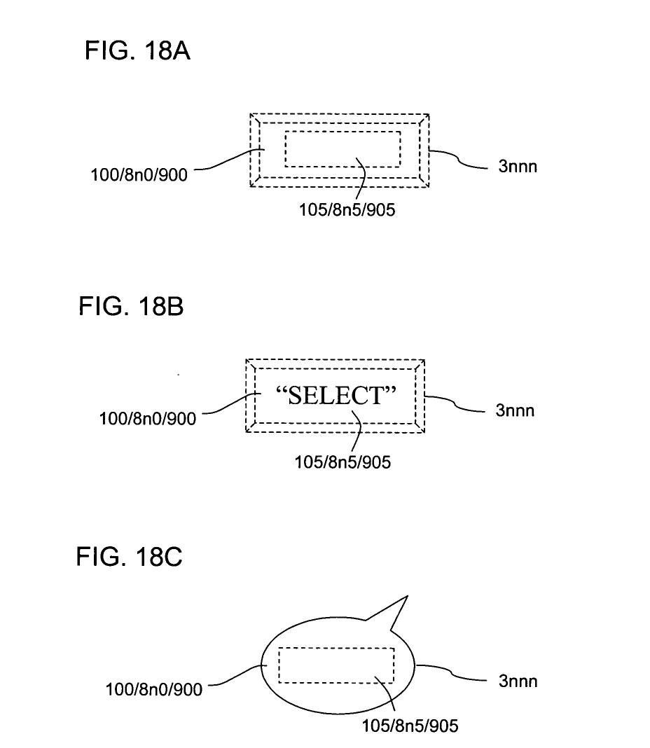

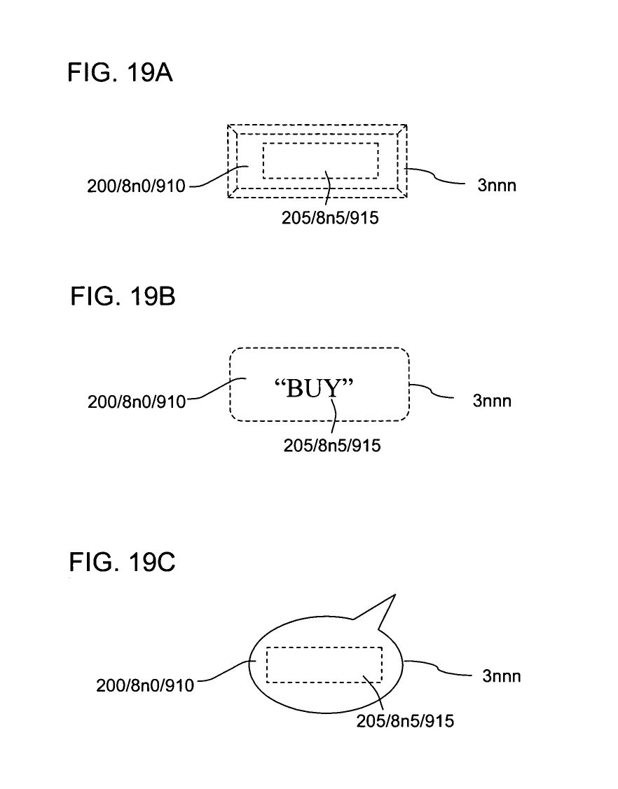

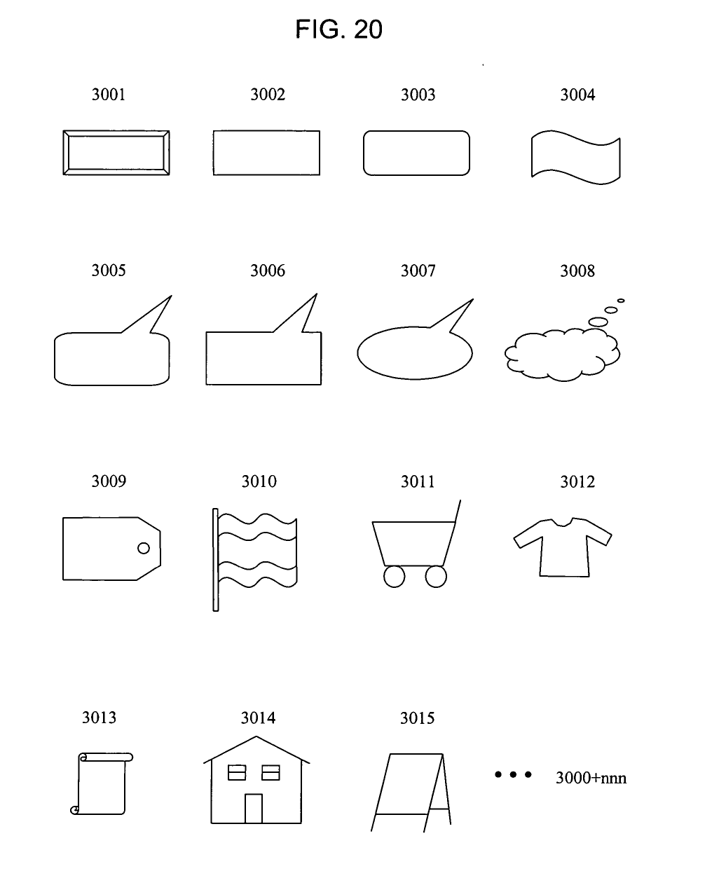

FIGS. 18A, 18B and 18C are drawings of alternative graphical objects 100, 8n0, and 900 for making a selection 127n, 15nn, and 192n. Horizontal boxes 105, 8n5, and 905 are shown corresponding to graphical objects for making a selection. Similarly, FIGS. 19A, 19B and 19C are drawings of alternative buttons for making a purchase decision 128n, 16nn, 193n, and 195n. Horizontal boxes 205, 8n5, and 905 are shown corresponding to graphical objects for making a purchase decision. It will be apparent to a person skilled in the art that these boxes may be vertical, diagonal or shape and that graphical objects 100, 200, 8n0, and 9n0 may have various alternative shapes 3nnn. With reference to FIGS. 2A through 2F, these graphical objects may be used when making a selection by method 500a, 500b, or 500e and when making a purchase decision by method 700a, 700b, or 700e. Other graphical objects 310a and 4n0 may be used when making a selection by 500c or 500d or making a purchase decision by method 700c or 700d.

FIG. 20 is a series of drawings of graphical objects having alternative shapes 3nnn. Alternative shapes for graphical objects include polygons, icons, and so on. It will be appreciated that some shapes or icons are more easily recognized as buttons than other shapes or icons. For example, graphical object 3001 appears to be a button to depress. It will also be appreciated that nearly any graphical object may be used. For example, graphical object 3011 is a drawing of a shopping cart, graphical object 3013 is a paper scroll, and graphical object 3014 is a drawing of a house. Hence, a graphical object representing the promoted object 310a may be suitable. With reference to FIGS. 5A through 5F, graphical object 3013 representing a contract or agreement for goods, service, or real property. With reference to FIGS. 6A through 6F, graphical object 3014 representing a house or real property.

The invention may be practiced on any computer or electronic device capable any manner or form of visual display. All types of computers, computer systems, and computer networks having the capability of a visual display can generally be programmed to operate computer games and interactive programs. Even those without capability of visual display can be programmed to operate a variety of computer games or interactive programs. In addition, many electronic devices can be programmed to operate a computer game or interactive program.

Computers and electronic devices may include any type of computer and computer system such as personal computers, laptop computers, notebook computers, handheld computers, arcade game machines, handheld games, video game systems, video game consoles, video game boxes, personal digital assistants, mobile computing devices, cable boxes, telephones, telecomputing devices, and telecommunication devices. Computer networks may include all types of networks such as local area networks (LANs), wide area networks (WANs), private virtual networks, peer-to-peer, world wide web (WWW), intranets, extranets, and the internet. One embodiment includes a game console of the type manufactured by Sony Electronics Corp. or Microsoft Corp. Another embodiment includes cable box of the type made by webTV. Still another embodiment includes a personal computer of the type manufactured by Dell Computers. Still yet another embodiment includes handheld computer or personal digital assistant. The computer processor may be a single integrated circuit or comprise multiple integrated circuits having different functions i.e. central processing unit (CPU), input-output (I/O) processing, video processing, sound processing, and so on. The display may be any type of display or projection system such as oscilloscope, vector tube, cathode ray tube (CRT), liquid crystal display (LCD), and any flat panel display, TFT, etc.

In one embodiment of the invention, goods may include equipment, gear, equipment, uniforms, clothing or the like. In another embodiment, services may include training, coaching, practice, tutoring educational programs or the like. In a further embodiment, real property may include developed or undeveloped parcels in one or more locales (e.g. cities, country clubs, resorts, housing subdivisions, planned unit developments, university campuses, corporate parks, etc.) where the virtual location may emulate the actual locale. A default location may be pre-determined by the computer program or the location may be selected from a group or list of locations. Other defaults may be predetermined depending on product(s) to be promoted. For example, only a single product may be promoted, or multiple products within a single brand, or multiple brands.

It will be appreciated that pre-game may include activities for either spectators or participants, or both. For spectators, one embodiment of the invention may be a pre-game show. A pre-game show may include a myriad of content such as commentary, scores, clips, statistics, and so on. For participants, another embodiment may include a training session as part of the pre-game. A training session may include instruction by one or more instructors having relevant expertise. A default instructor may be pre-determined by the computer game or the instructor may be selected by a player from a group or panel of instructors. The group or panel may include various celebrities or commercial instructors. For example, the player of a golf computer game could select a particular golf instructor from a panel of golf instructors. The selected instructor may extend offers to the player regarding other products and services. For example, the golf instructor may endorse or in some manner promote name brand equipment and/or programs of additional golf lessons. The player may or may not pay a fee to select the instructor. Accordingly, the computer game may be used to promote instructors and other products including goods or services associated with training.

Another embodiment of the invention may include a warmup or practice session. The practice session may be a virtual environment emulating the practice area including equipment, gear, and/or clothing. Play may include no players, one player, or multiple players. In addition, play maybe player-controlled or simulated. In an embodiment of the invention, the practice sessions include promotional displays of merchandise, products, or services. Promotional displays of merchandise may include generic or brand name products. Ps, TMx, trademarks, tradenames use of brand name equipment.

Still another embodiment of the invention may include a visit to an area for preparation including a clubhouse, pro shop, locker room, gear shop, pit, dugout, batting cage, deck, bench, sideline, backstage, wing, or dressing room. A further embodiment is visiting a virtual shopping mall. In this way, any product may be advertised, marketed, or sold.

Still yet another embodiment of the invention is the providing of incentives to purchase promoted products. For example, purchase of a product could boost speed, skill, or power of a player during game play. In this way, an incentive is bestowed on a prospective purchaser to encourage the purchase of a promoted product. A further embodiment of the invention includes an incentive of the bestowing stealth, wisdom, invincibility, or another attribute on a player during the game. In one embodiment, the enhanced speed, power, or other attribute is related to the product or service purchased. For example, purchase of a golf club or golf ball would bestow on the player who purchases the club or ball a longer drive down the fairway. In this way, the promotion is better targeted to a person who has significant incentive to purchase promoted products.

From the foregoing it will be appreciated that although specific embodiments of the technology have been described herein for purposes of illustration, various modifications may be made without deviating from the spirit and scope of the invention. For example, the user may lease products or services rather than purchase them outright. Also, the user may provide personal information as consideration in addition to or in lieu of payment for products and services. The promotional system may output a selected promotion in ways other than visually displaying promotions on a screen. For example, a promotion may be output in an audio form. Further, the invention can be used with personal computers, computer terminals, television sets, video game machines, video game boxes, web TV, cable TV, video consoles, laptop computers, notebook computers, handheld computers, personal digital assistants, telephones, cell phones, pagers, and so on. Accordingly, the invention should be broadly construed and is not limited except with respect to the appended claims.

What is claimed is:

1. A computer-implemented method for promotion of products within an electronic game, comprising:
receiving at least one input from a player, whereby the player is identified;
displaying at least one graphical object representing a promoted product, whereby the promoted product is brought to the attention of the player; and
in response to at least one action being performed by the player, processing at least one request from the player, whereby the promoted product is selected.

2. The method of claim 1, wherein, in response to a first action being performed by the player, the player receives at least one item of information about the promoted product without requiring a second action being performed by the player.

3. The method of claim 1, wherein the graphical object includes at least one item of information which identifies the promoted product.

4. The method of claim 1 wherein, in response to at least one action being performed by the player, the promoted product is added to an electronic shopping cart.

5. The method of claim 1 wherein, in response to at least one action performed by the player, a purchase of the promoted product is completed.

6. The method of claim 1 wherein the promoted product is a good.

7. The method of claim 1 wherein the promoted product is a service.

8. The method of claim 1 wherein the promoted product is a contract.

9. The method of claim 1 wherein the promoted product is an interest in a real property.

10. A computer system which embodies the method of claim 1.

11. A computer program which, when executed by a computer, performs the method of claim 1.

12. An image on the display generated according to the method of claim 1.

13. A computer-implemented method for promotion of products within an electronic game, comprising:
displaying at least one graphical object identifying a promoted product, whereby the promoted product is brought to the attention of the player;
in response to at least one action being performed by the player, modifying an operational parameter of the electronic game; and
wherein the operational parameter is capable of enhancing the performance of the player.

14. The method of claim 13 wherein the speed of the player is enhanced.

15. The method of claim 13 wherein the power of the player is enhanced.

16. The method of claim 13 wherein the dexterity of the player is enhanced.

17. The method of claim 13 wherein the endurance of the player is enhanced.

18. The method of claim 13 wherein the promoted product is a good.

19. The method of claim 13 wherein the promoted product is a service.

20. The method of claim 13 wherein the promoted product is a contract.

21. The method of claim 13 wherein the promoted product is an interest in a real property.

22. A computer system which embodies the method of claim 13.

23. A computer program which, when executed by a computer, performs the method of claim 13.

24. An image generated on a display generated according to the method of claim 13.

25. A computer system comprising:
a display;
at least one processor in communication with the display;
at least one storage medium in communication with the processor;
wherein the processor operates at least a promotion engine based at least in part on instructions stored on the storage medium;
wherein the promotion engine conducts at least one promotion;
wherein the promotion includes displaying at least one promoted product on the display; and
in response to at least one action being performed by the player, modifying the instructions with respect to at least one operating parameter.

26. The method of claim 25 wherein the processor operates a graphics engine.

27. The system of claim 25 wherein the promotion engine conducts at least one promotion within a computer game.

28. The system of claim 25 wherein the promotion engine conducts at least one promotion before a player commences play of a computer game.

29. The system of claim 25 wherein the promotion engine conducts at least one promotion after a player completes play of a computer game.

30. The system of claim 25 wherein, in response to at least one action being performed by a player, the promoted product is selected.

31. The system of claim 25 wherein, in response to at least one action being performed by a player, the proposed product a player is purchased before, during, or after play of a computer game.
